(19) United States
(12) Patent Application Publication
(10) Pub. No.: US 2005/0216626 A1
(43) Pub. Date: Sep. 29, 2005

(54) Computer switch box

(76) Inventors: Richard Tran, Santa Ana, CA (US); Nancy Tran, Santa Ana, CA (US)

Correspondence Address: Drummond & Duckworth;East Tower, Suite 440, 5000 Birch Street, Newport Beach, CA, 92660, US

(21) Appl. No.: 10/808,766

(22) Filed: Mar. 24, 2004

(51) Int. Cl. G06F 13/00

(52) U.S. Cl. 710/100

(57) ABSTRACT

A computer system including a switch box is provided for controlling the selective activation and deactivation of the computer systems' memory storage devices. The switch box includes one or more pairs of switches with each pair including a power switch and a signal switch. The power switch selectively provides power to the corresponding power switches. Meanwhile, the signal switch selectively provides an open or closed circuit for allowing or restricting the transmission of data signals between the computers processor and memory storage device.

### BACKGROUND OF THE INVENTION

The present invention relates to computer processing systems. More particularly, the present invention relates to protection devices for enabling and disabling memory storage devices within a computer system so as to protect against unintentional loading or downloading of information to and from a computer memory device. As used herein, the term “computer memory device” is intended to have its broadest meaning to include any known or anticipated structure for storing information within a computer system. Present memory storage devices include hard drives, floppy drives, CD ROMs, Zip™ drives, etc.

The development of personal computers and mainframe computers experienced considerable growth during the 1970s. These computers were mostly invulnerable to improper access since they were installed in high security environments or provided limited access to unauthorized personnel. However, during the 1980s and 1990s, the networking of computers, and particularly personal computers, greatly contributed to computer system vulnerability. This vulnerability has resulted in malicious codes, typically referred to as computer viruses, being transmitted into and out of computer systems without authorization. The virus propagates itself and spreads Wherever it can gain access through an interconnected computer system. Where a computer containing a virus is connected to the Internet, the virus can be transmitted virtually anywhere. Many of these viruses travel to all active computer drives and from there corrupt or destroy data while transmitting themselves to those listed on the computer users' email address lists. This has resulted in billions of dollars in losses worldwide.

A computer system memory storage device is the component most vulnerable to attack by a virus. Memory storage devices are areas where all “data” reside which include all user application data (for example data base information, financial information, institutional records, etc.) all application software programs, and even the operating system software itself. A single incident of contamination by a virus may totally erase or render the storage device useless to the point that even the most knowledgeable programmer is unable to recover data.

An additional problem encountered by interconnecting computer systems using networks, such as the Internet, wide area networks (WAN) and local area networks (LAN), is that memory storage devices become vulnerable to unauthorized or undesirable theft of information. For example, computer hackers have “hacked” their way into various computer systems and stolen significant amounts of information. Again, this has resulted in millions, if not billions, of dollars worth of losses.

The advent of file-sharing Internet sites including Napster™ and Kazaa™ have resulted in persons intentionally and unintentionally sharing, in other words downloading, their files to unknown persons all over the Internet. Again, it would be desirable to control the dissemination of such information.

Many persons include more than one operating system on their computer and many programs may be incompatible. Moreover, there has been an increasing demand for storage space on computers. This incompatibility between operating systems and programs and increased demand for storage has resulted in persons mounting more than one storage device within a single central processing unit. As it has become more cost effective to mount additional storage devices, virtually all computer systems have multiple memory storage devices including combinations of hard drive, floppy drives, CD ROMs, etc.

The addition of more storage devices, however, does not protect memory from corruption if the computer comes under attack by a virus. The only known way of protecting a user's software programs, data and documents is by storing a copy on a secondary storage device, such as a second hard drive, and then taking the secondary memory storage device out of the data stream.

When such a companion or secondary memory storage device is used on a single computer, it is desirable to be able to selectively isolate the memory storage device or devices from outside influence without inhibiting the computer-user's ability to access information from the secondary drive as quickly and as efficiently as needed. Thus, there is a significant need for a system that not only isolates a memory storage device from Internet corruption, but also isolates a memory storage device from conventional networks for providing confidentiality and protection against viruses, hacking and file-sharing.

In light of the relatively recent origin of the problems, there have been few innovators in the computer field that have proposed protection which is both effective and affordable for the average user. Virus protection is typically provided by software programs such as those available from McAfee™, Norton™ and others which focus on detecting viruses being spread on an ongoing basis. Unfortunately, these virus protection programs are not infallible and they do not provide protection against others downloading ones files without authorization.

An additional attempt to protect memory storage devices from unwanted access is to provide the storage device with some kind of ability for turning off the “read” or “write” function. For example, many tape and disc storage devices offer a switch for turning off the “write” function. Large mainframe computers have capabilities for turning on and off individual memory storage devices such as magnetic tape or the like.

Unfortunately, very limited attempts have been made to protect the memory storage devices on individual personal computers. One such attempt is disclosed in U.S. Patent Application 2003/1077403. This reference describes a switching system which will activate and deactivate the power supply to individual storage devices such as hard drives and CD-ROMs. This construction provides significant protection to a memory storage device as access is completely eliminated when the power supply to the memory storage device is disconnected. Unfortunately, however, each time the power is deactivated and reactivated to the memory storage device, the unit must reboot taking an undesirable amount of time. It would therefore be desirable to provide protection to a memory storage device without necessarily deactivating the power to it.

### SUMMARY OF THE INVENTION

Briefly, in accordance with the invention, I provide a computer system including switch box for selectively controlling the power supply and data transmission to and from a computer memory storage device.

The computer system includes a computer processing unit, monitor, and input devices such as a keyboard and mouse. Within the computer processing unit (CPU), a power supply, processor and memory storage devices are provided. In addition to these traditional components, the computer system of the present invention includes a switch box which controls the operation of one or more memory storage devices within the CPU. The switch box includes a housing structured to mount within the traditional CPU tower. More particularly, the face of a CPU tower is usually provided with a plurality of bays for the mounting of externally accessible peripherals such as a CD-ROM, DVD reader/writer, and a floppy disk drive. The switch box housing of the present invention is constructed to reside within one of these bays for convenient access by the computer user and simplistic integration into the central processing unit. The switch box includes a plurality of electrical on/off switches, which are preferably push-button switches mounted to the switch box's faceplate. As explained in greater detail below, the push-button switches control the power supplied to individual memory storage devices and control the transmission of commands to the memory storage device so as to enable or disable unauthorized access to the memory storage device. In a preferred embodiment, the switch box includes a total of six switches. The six switches are separated into three pairs with each pair controlling both the power and data supply of three individual memory storage devices.

The preferred switch box includes at least one input power connector which electrically connects via a power cable to the CPU's power supply. In a preferred embodiment, the switch box includes two input power connectors, both of which are connected by power cables to the power supply, to provide redundancy. In accordance with most present day computer systems, the power connectors, and corresponding power cables, include a 12 volt input, a 5 volt input and two ground paths.

The switch box of the present invention also includes output power connectors electrically connected to the input power connectors. The power supplied to the output power connectors is controlled by the corresponding switches positioned on the switch box face plate which are electrically connected in series between the input and output power connectors. More particularly, the output power connectors electrically connect to the CPU's power supply through the power cables, switch box input connectors and the switch box's internal wiring. The output power connector, in turn, connects to individual memory storage devices. Power supplied to the memory storage device is controlled using a corresponding switch so that the memory storage device can be activated and deactivated as desired by the computer's user.

In addition to power control, the switch box provides control over the transmission of data to and from a memory storage device. Computer systems include a data cable which connects memory storage devices to the computer's processor. These signal cables typically include dozens of wires and a corresponding number of pins or sockets within electrical connectors. For example, most memory devices connect to the processor using a 40 channel “IDE” cable. Typically, one of the wires and signal cables, and corresponding pins or sockets, is dedicated to transmitting command signals from the processor to the memory storage device. In standard personal computers, this channel is referred to as the “interrupt” channel and is typically provided through pin number 31 in the IDE cable which connects the computer's processor to a hard disk drive.

It is a primary object of the present invention to provide a switchable control to enable or disable the transmission of the interrupt signal from the processor to the memory storage device. To this end, the switch box includes one or more switches which electrically open or close the interrupt channel. These “signal” switches are electrically connected in series with the interrupt channel. To this end, preferably a traditional IDE cable connector is modified to allow 39 of the 40 channels to be connected directly from the processor to the memory storage device through the IDE cable. However, in a preferred embodiment of the inventor, the IDE cable connector mating to the memory storage device is modified so that signals transmitted from the processor through the interrupt channel into pin number 31 are diverted by a separate signal cable to the switch box of the present invention. The interrupt signals are then transmitted through one of the switches and directed back to the IDE cable pin 31 for transmission into the memory storage device. Provision of the switch in series with the interrupt channel allows for the computer user to selectively enable or disable the interrupt channel. With the interrupt channel disabled, in other words in an open condition, the computer processor cannot transmit signals to the memory storage device, resulting in the memory storage device being unable to store information or download information. In other words, placing the interrupt channel in a disabled condition makes the memory storage device completely inaccessible. However, retriggering the switch to a closed position allows signals to be transmitted between the memory storage device and processor.

The combination of a power and signal enable-disable of the present invention provides security to a computer memory storage device that was previously unavailable.

Therefore, it is an object of the present invention to provide a switch box which provides added security to a computer system.

It is an additional object of the present invention to provide a switch box which is inexpensive to manufacture, easy to install and convenient to use.

These and other specific object and advantages of the invention will be apparent to those skilled in the art from a review of the following detailed description taken in conjunction with the drawings.

### BRIEF DESCRIPTION OF THE DRAWINGS

FIG. 1 is a perspective view of a central processing unit (CPU) of the present invention;

FIG. 2 is a top plan view of the switch box used within the computer system of the present invention;

FIG. 3 is a side cutaway plan view of the internal components of the central processing unit of the present invention;

FIG. 4 is a side view illustrating the connectors within a preferred switch box of the present invention;

FIG. 5 is a side view illustrating the connectors of a traditional hard drive;

FIG. 6 is a rear view of the switch box of the present invention including signal cables and power cables which mate to a controlled memory storage device;

FIG. 7 is an exploded perspective view illustrating a preferred construction for rerouting the interrupt channel from the processor to the memory storage device through a signal switch;

FIG. 8 is a perspective view illustrating a preferred construction for rerouting the interrupt channel from the processor to the memory storage device through a signal switch; and

FIG. 9 is a side cutaway view illustrating a computer processing unit of the present invention including a switch box connected to memory storage devices by power cables and signal cables.

### DETAILED DESCRIPTION OF THE INVENTION

While the present invention is susceptible to the embodiment in various forms, as shown in the drawings, hereinafter will be described the presently preferred embodiments of the invention with the understanding that the present disclosure is to be considered as a exemplification of the invention and is not intended to limit the invention to the specific embodiments illustrated.

The computer system of the present invention includes the traditional components typically found within the ubiquitous personal computer system. With reference to the Figures, the computer system includes a central processing unit 31, including a housing 32 for containing various components. These components include a power supply 33, a processor, also commonly referred to as a motherboard 35, and numerous memory storage devices. As shown in the figures, these memory storage devices include CD-ROMs 37, hard drives 39 and 41, or additional units such as Zip drives, floppy drives, etc. The CPU 31 also contains various cables for connecting the power supply to the various units and signal cables for connecting memory devices to the processor. Not shown in the figures, the computer system includes a monitor and one or more tactile input devices such as a keyboard, mouse, video camera, gaming joystick, etc. Though not described herein, the computer system of the present invention may include alternative memory storage devices or alternative tactile input devices without departing from the spirit and scope of the invention.

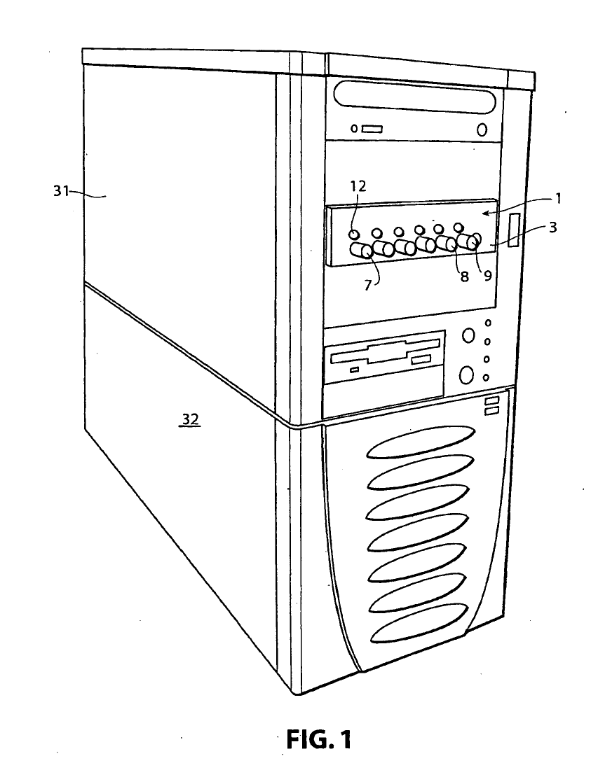

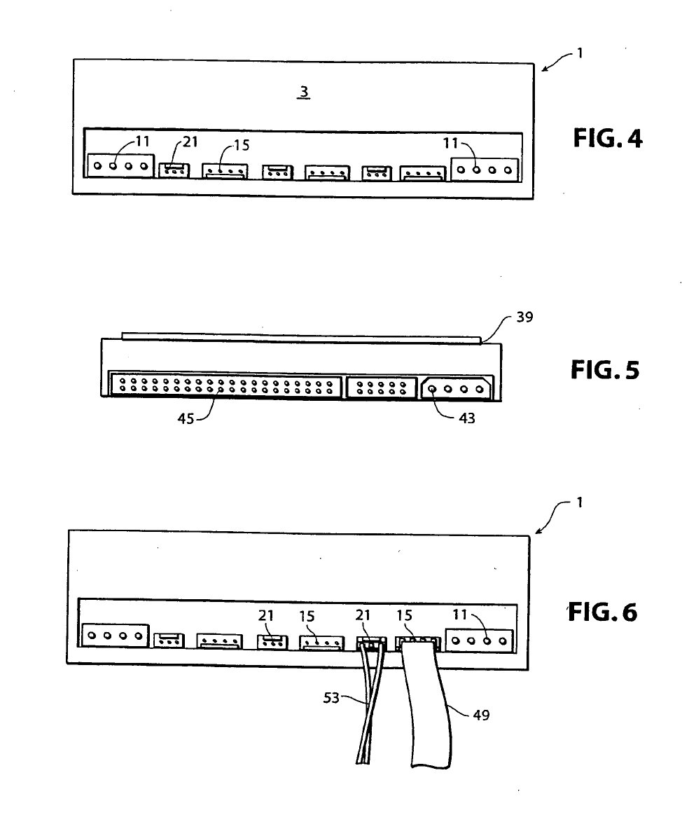

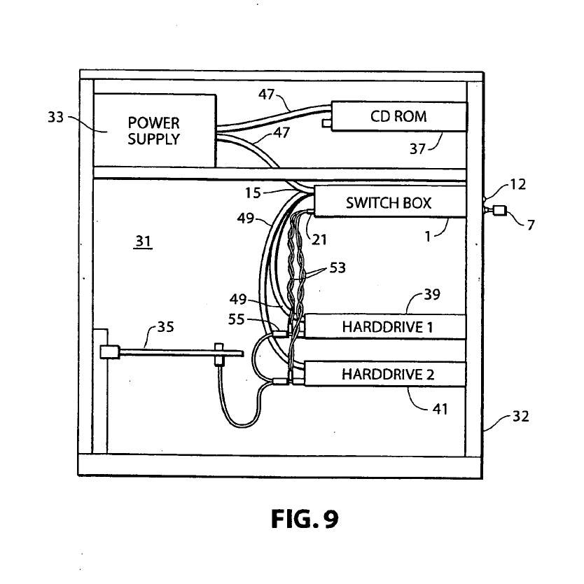

In addition to the traditional components found within a computer system, the computer system of the present invention includes a switch box 1. With a reference to FIGS. 1-9, the switch box 1 includes a housing 3 and is preferably constructed to be positioned within one of the plurality of bays formed in a CPU for mounting externally accessible peripherals.

In operation, the switch box 1 of the present invention controls the operation of one or more memory storage devices which are electrically connected to the switch box. To this end, the switch box 1 includes a plurality of manual on/off switches 7 for selectively creating an electrically open condition or closed condition. As shown in the figures, in a preferred embodiment, the switches are push button on/off switches. However, the switches may be rotary, toggle or other type of switches without departing from the spirit and scope of the invention. Moreover, the switch box may include lights, such as LEDs 12 for indicating the open or closed condition of an adjacent switch.

As shown in the figures, in a preferred embodiment the switch box includes a total of six switches for controlling the operation of up to three memory storage devices. The six switches are separated into three pairs of switches with each pair including a power switch 8 and a signal switch 9. The power switch controls the corresponding power to a memory storage device, while the signal switch 9 controls the transmission of data signals to and from the memory storage device. Selective operation of these signal switches enables a computer user to deactivate the memory storage device while maintaining the power to the memory storage device by simply deactivating a corresponding signal switch 9. Meanwhile, entire operation of the memory storage device can be disabled by eliminating all power to the unit using a corresponding power switch 8.

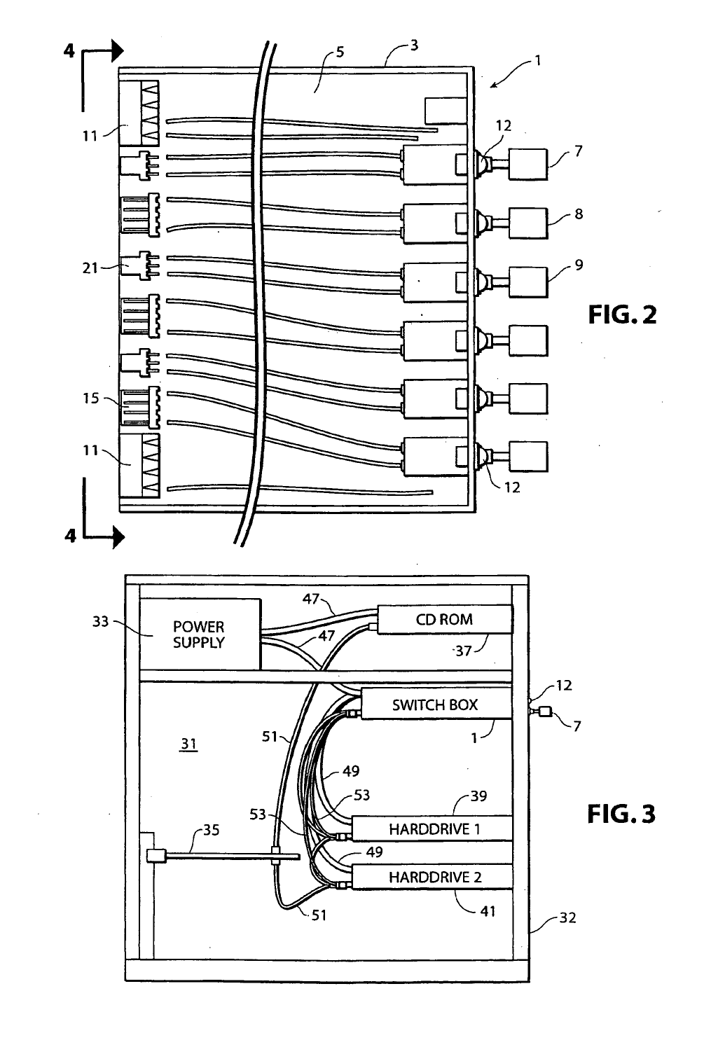

For simplicity, the memory storage devices will be referred to hereinafter as a hard drive, though alternative memory storage devices may be just as easily used with the switch box of the present invention. With reference to FIG. 3, the power supply does not supply power directly to the hard drive as traditionally constructed. Instead, the switch box of the present invention includes a power cable 47 which directs power to the switch box's input power connectors 11. Preferably, the power cable 47 includes four wires including a 12 volt, 5 volt and 2 ground. With reference to FIG. 2, the 12-volt, 5-volt and ground paths are then electrically connected to the power switches 8. The power switches 8 provide a selective open and close condition to all four electrical paths before directing these electrical paths to output power connectors 15. As shown in the figures, preferably the switch box includes a pair of input power connectors 11 to provide redundancy. However, these input power connectors then split the individual power and ground paths into three sets of corresponding output power channels for redirection to memory storage devices, such as hard drives 39 and 41. The redirection of power from the switch box to the hard drive is accomplished by using four wire power harnesses 49. In operation, power from the power supply to the hard drive can be selectively activated and deactivated using a corresponding push button switch 8. For example, where hard drive 1 has been electrically connected to the power supply through the left hand switch of the switch box, the hard drive 1 can be completely disabled by removing all power to the hard drive by placing switch one in a open condition. The hard drive can then be “rebooted” by providing power to the hard drive by placing left hand switch in a closed position. Additional hard drives can be activated and deactivated using alternate switches provided within the switch box.

There are numerous instances where computer users wish to deactivate access to a memory storage device, such as a hard drive, without completely deactivating power to the unit which requires lengthy reboot procedures at a later time. To provide security to the memory storage device without requiring the disablement of power to the unit, applicant switch box further includes one or more signal switches 9 which are provided for selectively activating or deactivating the electrical paths from the processor to the memory storage device.

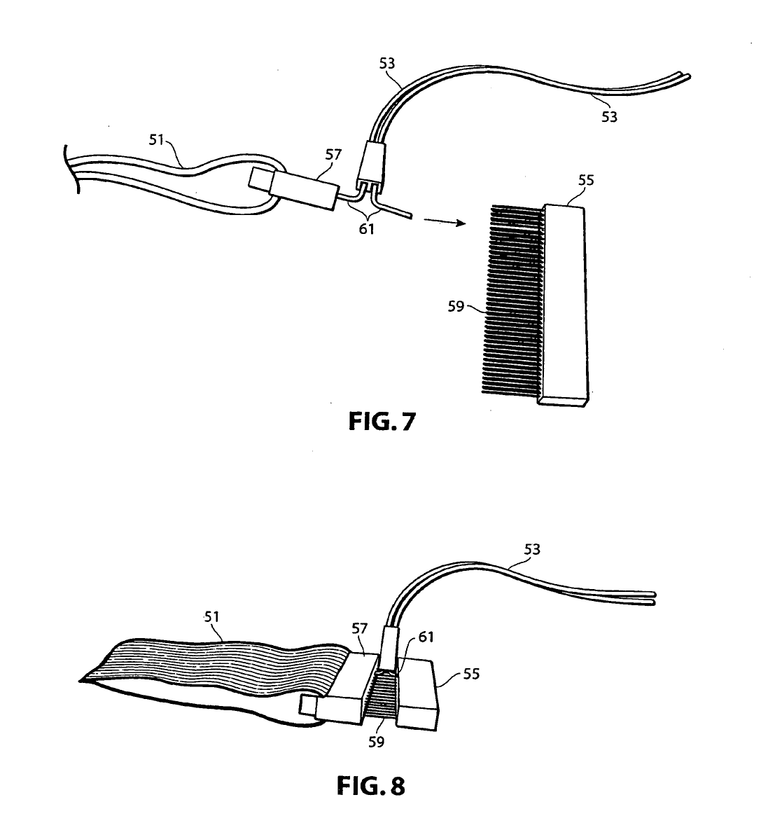

In a preferred embodiment, the computer system includes traditional data cable 51 which connects the processor 35 to one or more hard drives 39 and 41, or other memory storage devices. However, preferable the interrupt panel, typically provided through pin 31, in a traditional IDE cable, is rerouted to pass through a controlling signal switch 9. The traditional signal path from the processor 35 to the hard drive 39 or 41 may be rerouted at any point between the two units. However, in a preferred embodiment, illustrated in FIGS. 7-9, the interrupt signal is rerouted from the IDE cable adjacent to the memory storage device. To this end, the computer system includes an additional interrupt connector 55 having a plurality of electrically conductive pins 59 for providing direct signal paths to and from the IDE cable 51 into the memory storage device 39 and 41. However, the computer system of the present invention further includes modified pins 61 for rerouting the interrupt channel into signal wires 53 which lead to the switch box 1 of the present invention. The signal wires 53 electrically connect to a signal switch 9 which selectively provides an open or closed circuit. With the switch in a closed circuit, the processor is capable of sending signals through the interrupt channel to the memory storage device. However, when the signal switch 9 is placed in an open condition the computer processor 35 is incapable of transmitting commands to the memory storage device thereby making the memory storage device incapable of storing information or transmitting information. In other words, placing the signal switch 9 in an open condition disables the memory storage device completely without removing power from the unit.

As shown in FIGS. 7-9, the rerouting of the interrupt channel may be accomplished using the combination of an intermediate connector and separate modified pins and signal cable 53. This construction is considered preferable when using preexisting data cables provided between the processor 35 and memory storage device. With reference to FIG. 3, in an alternative construction the IDE cable 51 is constructed to include signal wires 53 for mating to the switch box's signal connectors 21.

Any number of memory storage devices can be controlled using the switch box of the present invention. As shown in the figures, a preferred switch box includes six switches for controlling the power and signal operation of three memory storage devices. However, any number of buttons may be included in the switch box for controlling any number of memory storage devices. In addition, the computer system may be wired to control some but not all memory storage devices. For example, as shown in FIG. 3, in a preferred construction hard drive 1 and 2 are electrically connected to the switch box so that the power and operation of the unit can be selectively activated or deactivated. However, the CD-ROM 37 is not connected to the switch box. Thus, the CD-ROM is incapable of being activated or deactivated in accordance with the present invention. Notwithstanding, the computer user may connect the CD-ROM to the switch box if additional security is desired.

Still additional modifications of the computer system of the present system can be made without departing from the spirit and scope of the invention. For example, herein is described a particular construction for disabling a signal path from the processor to a memory storage device without disabling power to the unit. However, alternative constructions wherein different signal paths are controlled through the switch box may be adopted without departing from the scope of the present invention.

1. A computer system:
a power supply;
a processor;
a memory storage device having a plurality of electrical input and output terminals, said electrical terminals including an control terminal for receiving control signals which control recording and transmission of information into and from said memory device;
an electrical harness for interconnecting said electrical terminals with said processor; and
a switch box including one or more manual switches, said switches including a control switch interconnected between said control terminal and said processor, said control switch having a first position allowing control signals to be transmitted from said processor to said memory storage device and a second position for preventing control signals to be transmitted from said processor to said memory storage device.

2. The computer system of claim 1 wherein said switch box includes a power switch interconnected between said power supply and said memory device, said power switch including a first position allowing power to be transmitted from said power supply to said memory device and a second position preventing power to be transmitted from said power supply to said memory device.

3. A computer system:
a power supply;
a processor;
a plurality of memory storage devices, said memory storage devices having a plurality of electrical input and output terminals, said electrical terminals of said memory storage devices including an control terminal for receiving control signals which control recording and transmission of information into and from said memory device;
an electrical harness for interconnecting said electrical terminals with said processor; and
a switch box including a plurality of manual switches, said switches including a plurality of control switches interconnected between said control terminals and said processor, said control switches having a first position allowing control signals to be transmitted from said processor to said memory storage devices and a second position for preventing control signals to be transmitted from said processor to said memory storage device.

4. The computer system of claim 3 wherein said switch box includes a plurality of power switches interconnected between said power supply and said memory storage devices, said power switches a first position allowing power to be transmitted from said power supply to said memory devices and a second position preventing power to be transmitted from said power supply to said memory devices.
